(19) United States
(12) Patent Application Publication
(10) Pub. No.: US 2006/0010766 A1
(43) Pub. Date: Jan. 19, 2006

(54) Polymerized wax candles

(76) Inventors: Richard Johnson, Batavia, IL (US); Kathy Plambeck-Knott, Carol Steam, IL (US); Margaret Szczerba, Carol Steam, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/889,918

(22) Filed: Jul. 13, 2004

(51) Int. Cl. C11C 5/00

(52) U.S. Cl. 44/275

(57) ABSTRACT

A candle made with a wax base and a synthetic thermoplastic rubber copolymer. The wax base may be prepared from a plurality of two or more different fuel sources including petroleum sources, animal sources, vegetable sources, synthetic sources and blends thereof. The synthetic thermoplastic rubber copolymer may be a diblock, triblock, radial block, multiblock copolymers, and blends thereof. In addition to the wax base and the synthetic thermoplastic rubber copolymer, candles made according to the invention can also include stabilizers, fragrances, dyes as well as other standard candle additives. The addition of the synthetic thermoplastic rubber copolymer allows for the production of high quality candles with improved shipping stability, controllable burn rates, less dripping and higher fragrance loading capabilities. Additionally, disclosed candles decrease processing times and percent defects as part of an improved manufacturing process.

### TECHNICAL FIELD

Candles are disclosed which comprise a wax base consisting of a mixture of at least two different fuel sources selected from the group consisting of petroleum matter, vegetable matter, animal fat matter and synthetic matter are blended with a copolymer of synthetic thermoplastic rubber copolymer additives. The copolymer additive is useful for binding wax fuels of dissimilar chemical and physical properties such as different compositions, polarities, melt points and oil contents within the candle. As a result, the production of quality candles with superior performance and stability can be achieved using a variety of different wax fuel sources and the previous problems associated with mixing different waxes together in a single candle are overcome. Methods of manufacturing candles comprising a wax base comprising fuel mixtures and a copolymer of synthetic thermoplastic rubber additives are also disclosed.

### BACKGROUND OF THE RELATED ART

Candles have long since been used as an accepted method of giving light, heat, scent, or for celebration or votive purposes. Candles made from a variety of wax bases are well known within the art. Typically, a wax base is derived from petroleum sources, vegetable sources, animal sources and synthetic sources. However, candles made from mixtures can suffer from inferior burn quality due to the non-homogenous nature of the mixture. For example, candles derived from fuel mixtures or wax mixtures can suffer from heat stability concerns due to free oil content derived from the fuels in the mixture.

The ability to utilize different wax fuel sources would be a great benefit to candle makers. Specifically, as prices of various waxes increase or decrease, it would be an advantage to candle makers to be able to take advantage of lower prices of a particular type of wax base while limiting use of higher priced wax bases. To date, however, there is not effective means for mixing different types of waxes in a single candle due to the chemical property differences of the wax bases that are currently available.

Specifically, petroleum waxes, vegetable waxes, animal fat waxes and synthetic waxes all differ in chemical composition, polarities, melting points and oil content. The blending of different waxes can be problematic and increase the tendency of a candle to bleed or sweat oil during use. Further, the burning properties of candles made from mixtures of different waxes can also be inferior.

Still further, the polarity of waxes used can often provide a limit to the amount of colorant or fragrance added. Typically, colorants and fragrance are of a more polar nature while the polarity of petroleum, animal, vegetable and synthetic waxes also vary greatly. Polarity differences and the amount of free oil among the lower cost waxes limits the amount of fragrance a candle maker can employ in a particular candle. Thus, in addition to providing candle makers with flexibility in terms of choosing which wax mixtures they can use, there is also a need to solve the problem of limits on the addition of more polar additives such as colorants and fragrances.

### SUMMARY OF THE DISCLOSURE

In satisfaction of the aforenoted needs, an economic method of binding candle wax fuels of dissimilar polarity and free oil content is disclosed. The free oils within the petroleum wax (or “petroleum matter”), vegetable wax (or “vegetable matter”), animal wax (or “animal matter”) and synthetic wax (or “synthetic matter”) are economically bound through the use of one or more copolymer additives. By adding the copolymer additive to a wax base comprising a plurality of wax fuels, high quality candles can be produced using mixtures of less expensive fuels of differing polarities as starting materials. As an additional benefit higher fragrance loads are also possible.

The copolymer additive, which is based on synthetic thermoplastic rubbers, may be diblock, triblock, radial block or a combination thereof. Copolymers of this type are well known, and are typically used as adhesives, sealants and coatings. For example, synthetic thermoplastic rubber copolymers produced under the trade name KRATON® (Kraton Polymers, Houston, Tex.) are used in a variety of environments.

A candle utilizing a wax base comprising a mixture of wax fuel and a synthetic thermoplastic rubber copolymer is also disclosed. The mixtures of two or more fuels can come from economical sources such as petroleum sources, vegetable sources, animal sources and synthetic sources. The copolymer used in conjunction with the candle may be a diblock, triblock, radial block, or combinations of diblock, triblock and radial block copolymers. The addition of copolymer to the wax base binds the oil portions of the various fuels within the wax, thereby permitting the production of candles with fuel mixtures of more cost-effective materials and higher fragrance loads having superior performance and stability parameters. Thus, current market price can be factor in the choice of wax fuels used because the copolymer additive enables previously incompatible wax fuels to be combined.

Some of the lower cost waxes that are presently not useful in the candle making process are low-melt paraffin waxes (slack wax), low melt partially hydrogenated vegetable waxes (palm or soy), low melt animal tallow waxes and low melt synthetic waxes (alpha olefin). Despite their lower cost, these low-melt waxes are not commonly used because they may melt or deform during shipping during hot months. The addition of the copolymer stabilizes and provides homogeneity to these low-melt wax mixtures in the production process and raises the slump resistance temperature in the finished candle. Thus, if low-melt wax mixtures are used, the concern over melting during shipping is obviated by the addition of the copolymer according to the invention.

As an additional method of cost savings, the disclosed candles result in reduced processing times and percent defects. Moreover, the candles can be produced using standard candle manufacturing facilities.

In addition to the cost saving benefits of using mixtures of lower grade fuels the addition of the copolymer has been found to alter the crystalline structure of the wax bases thereby allowing for the manipulation of the burn rate of the candles. The altered crystalline structure provides multiple temperature gradients throughout the candle causing burn rate manipulation. Thus, the disclosed candles have longer burn times than conventional candles. In addition, to longer burn times, the multiple temperature gradients of the candle provides safety benefits by preventing spillovers because the edges of the candle are substantially cooler than the center pool.

The disclosed candles are useful for suspending a variety of safety, aesthetic and performance-enhancing additives. Through careful temperature control during processing various windows of viscosity can be established to suspend various additives. Glitter and other aesthetic additives may also be suspended in the candle to provide wax candles of unique decorative effects not achievable without the thermoplastic copolymer.

### DETAILED DESCRIPTION OF THE PRESENTLY PREFERRED EMBODIMENTS

A candle made of composition having a wax base comprising a plurality of wax fuels and a thermoplastic copolymer is disclosed. The copolymer is present in an amount of ranging from about 0.125% by weight to about 10% by weight. Preferably, the copolymer is present in an amount ranging from about 0.15% by weight to about 2% by weight.

The copolymer is based on synthetic thermoplastic rubbers, and may be diblock, triblock, radial block or a combination of the three. The preferred synthetic thermoplastic rubbers are sold under the KRATON® trade name. The KRATON® rubber polymers are elastomers with a high strength and low viscosity. Additionally, KRATON® has a unique molecular structure of linear diblock, triblock or radial polymers. Each molecule of the KRATON® rubber is believed to consist of block segments of styrene monomer units and rubber monomer units and each block segment may consist of 100 monomer units or more. The most common structure is the linear ABA block type; styrene-butadiene-styrene (SBS) and styrene-isoprene-styrene (SIS), the KRATON® D series. A second-generation polymer of this series is the KRATON® G series, which are styrene-ethylene-butylene-styrene type (S-EB-S) polymers. Diblock polymers include the ABA type and the SB, styrene-ethylene propylene (S-EP) and (S-EB). The ABA structure of the KRATON® rubber molecule has polystyrene end blocks and elastomeric midblocks. This series of polymers is sold commercially and indicated as being major compounding ingredients or additives in adhesives, sealants and coatings, asphalt modifications for roads and roofing, polymers modification, thermoset modification, and oil modification including use as viscosity index improvers, greases and gels. The KRATON® G rubbers are indicated as being compatible with paraffinic and naphthionic oils and the triblock copolymers are reported as taking up more than 20 timers their weight in oil to make a product which can vary in consistency from a “gelatin-like” to a string elastic rubbery material depending on the grade and concentration of the rubber.

The ability of a synthetic thermoplastic rubber copolymer to bind oil of dissimilar polarities allows for the use of inexpensive alternatives for the fuel source or wax base. For example, in the case of paraffinic waxes, instead of using wax that has had all of the oil burned off through the expensive refining process, an inexpensive “slack wax” can be used. In the case of vegetable fuel source, the partial hydrogenation process works well with both palm and soy of varying fatty acid compositions. In the case of animal fuel sources a less purified grade tallow can be used. And, finally, in the case of a synthetic fuel source a less purified grade synthetic paraffin derived by the Fischer-Tropsch process or a less purified grade alpha olefin can be employed. Normally, the use of fuel sources of such lower grades would not produce a candle of suitable quality because of the free oil present therein. However, by blending lower grade fuel sources with the appropriate amount of the synthetic thermoplastic rubber copolymer, the total oil content can be bound. Thus, a high quality candle can be produced from a mixture of relatively inexpensive wax sources.

Moreover, the addition of the synthetic thermoplastic rubber to a wax base of a candle significantly improves the shipping stability characteristics of the candle. Often, candles that are prepared with a lower quality wax mixtures are damaged by heat during hot shipping months. This problem is overcome in candles that utilize the synthetic thermoplastic rubber copolymer according to the invention. The reason for this is that the copolymer actually works to raise the slump resistance temperature of the wax base and provide a rubberizing of the crystalline structure. As such, the addition of the copolymer to a wax base reduces the concerns of shipping candles in hot months.

The wax base used in the candle compositions is the fuel source for the candle. The disclosed wax bases includes a plurality of wax fuels or waxes that may come from a variety of sources. For examples, the wax base may be made from mixtures of petroleum matter, vegetable matter, animal-fat matter and synthetic matter. These mixtures of two or more fuels comprise ratios ranging from about 80/20 to about 20/80 weight percent. Preferably, the wax base mixture is present in a candle composition in an amount greater than about 50 percent by weight.

The candle composition may also include other additives such as fragrance oils, stabilizers, dyes, hydrocarbon oils and vegetable oils. Fragrance oils may be added in an amount up to about 10 weight percent. Another very important side benefit of this invention is the binding of the fragrance oil such that higher percentages of fragrance oil can be utilized without the negative of fragrance syneresis or leaching. Stabilizers (UV inhibitors or anti-oxidants) may also be added in an amount of up to about 1 percent by weight. Dyes may be added in an amount of up to about 2 percent by weight. Finally, hydrocarbon oils or a vegetable oils may be added in an amount of up to about 10 percent by weight. Those skilled in the art will recognize other additives commonly used in candle making can also be added.

Candles prepared from compositions according to this disclosure are made in a conventional manner. The candles will include a body portion and a least one wick that is disposed within the body. Depending on manufacturing capabilities, the body of the candle may be formed in a variety of different shapes and sizes. Additionally, multiple wicks may be found within the candle.

Bum testing of candles made in accordance with this disclosure reveals that the addition of the synthetic thermoplastic copolymer to the homogeneous wax base alters the crystalline structure of the wax base thereby allowing for dynamic and unexpectedly good bum characteristics. One such characteristic is revealed by thermal photography.

When candles are lit, they typically produce a wax pool in the area immediately adjacent the wick. The liquefied wax that becomes the fuel for the candle to maintain its flame. Thermal photography reveals that conventional candles demonstrate large uniform temperature wax pools. As a candle bums this uniform wax pool expands outward with time until it reaches the candle edge and dangerous spillage often occurs. Candles produced according to the disclosure, however, minimize the risk of spillover because of the addition of the synthetic thermoplastic copolymer which alters the crystalline structure of the wax base mixture. For example, when lit, the area immediately adjacent to the wick can bum at one temperature. Moving radially away from the wick, the temperature gradient rings provide a wax pool of lower and lower pool temperatures. By careful experimentation regarding the percentage of copolymer, one can formulate a spill free candle of narrow diameter. This gradual temperature decrease away from the wick creates a natural well in which the wax settles.

One method of preparing begins by heating the wax base mixture to a temperature within a range from about 170° to about 220° F. After heating, the copolymer additive is mixed in for about 30 minutes or until homogeneous. Upon the completion of mixing, the batch is cooled to a temperature ranging from about 150° to about 190° F., preferably about 170° F., whereupon the desired additives, such as stabilizers, dyes, hydrocarbon oils, vegetable oils, fragrances, etc. can be added. After the addition of the additives, the entire composition should again be mixed until it is homogeneous. Preparation of the candles is completed when the composition is poured into molds at a temperature ranging from about 150° to about 190° F., preferably about 170° F.

An alternative method of preparing candles includes the initial step of preparing a copolymer pre-mix in lieu of mixing the full amount of copolymer into the full amount of wax base. This pre-mix may contain from about 1% to about 49% by weight copolymer, and about 51% to about 99% wax base. Due to the fact that the viscosity of the copolymer pre-mix is directly related to the amount of copolymer present, it is preferable to use a pre-mix containing from about 8% to about 12% by weight copolymer, and about 88% to about 92% wax base. The pre-mix is prepared by first heating the requisite amount of wax base to a temperature within the range of from about 190° F. to about 220° F. After heating the wax, the next step is to add about half of the copolymer. That composition is then mixed until the copolymer is in solution. The remaining copolymer is then added in and mixed until the entire solution is homogeneous.

Preparation of the final candle composition using the copolymer pre-mix is very similar to the preparation without the copolymer into the heated wax base directly, the copolymer pre-mix is added to the heated wax base. Thus, the first step is to heat the wax base to a temperature within the range of 170° F. to about 220° F. After heating, the copolymer pre-mix is mixed in for about 30 minutes or until homogeneous. Upon the completion of mixing, the batch is cooled to a temperature ranging from about 150° to about 190° F., preferably about 170° F., whereupon the desired additives, such as stabilizers, dyes, hydrocarbon oils, vegetable oils fragrance oils, etc., can be added. After the addition of the additives, the entire composition should again be mixed until it is homogeneous. Preparation of the candles is completed when the composition is poured into molds at a temperature ranging from about 150° to about 190° F., preferably about 170° F.

The aforementioned preparation methods can be employed using standard candle manufacturing facilities. Moreover, candles produced according to this disclosure reduce processing times and percent defects. These added benefits work to further reduce the costs of producing candles.

### EXAMPLE 1

A candle having a wax base made from a mixture of vegetable and petroleum matter was prepared in accordance with the described protocol. The wax base is made from about 55% vegetable matter such as a partially hydrogenated soy or palm oil and 45% petroleum matter such as a fully refined or semi-refined paraffin. The wax base makes up about 93% of the candle composition. The remaining 7% is made up of the synthetic thermoplastic rubber copolymer and other described additions such as fragrance oils, stabilizers and dyes.

### EXAMPLE 2

A candle having a wax base made from a mixture of petroleum and animal matter was prepared in accordance with the described protocol. The wax base is made from about 80% petroleum matter such as a fully refined or semi-refined paraffin and 20% animal based tallow matter. Suitable animal-fat sources include tallow-based fatty acids. The wax base makes up about 93% of the candle composition. The remaining 7% is made up of the synthetic thermoplastic rubber copolymer and other described additives such as fragrance oils and dyes.

### EXAMPLE 3

A candle having a wax base made from a mixture of petroleum matter and synthetic paraffin waxes and alpha olefins is prepared in accordance with the described protocols. The wax base is made from about 50% petroleum matter such as a semi-refined paraffin, 25% of a synthetic paraffin matter such as Calista made by the Shell Company and 25% alpha olefin matter by the Chevron Company. The wax base makes up 88% of the candle composition. The remaining 12% is made up of the synthetic rubber copolymer and other described additives such as fragrance oils, anti-oxidants and dyes.

### EXAMPLE 4

A candle having a wax base made from a mixture of vegetable matter and synthetic paraffin matter is prepared in accordance with the described protocols. The wax base is made from 75% vegetable matter such as a partially hydrogenated soy from the Archer Daniels Midland Company and Calista synthetic paraffin from the Shell Company.

While the disclosed candles and manufacturing methods have been described in detail and with reference to specific embodiments, it will be apparent to one skilled in the art that various changes and modifications can be made therein without departing from the spirit and scope of this disclosure.

What is claimed is:

1. A candle composition comprising:
a wax base mixture comprising a plurality of different wax fuels; and
a copolymer additive selected from the group consisting of diblock, triblock, radial block, multiblock copolymers of synthetic thermoplastic rubbers and mixtures thereof.

2. The candle composition of claim 1, wherein the plurality of different wax fuels are selected from the group consisting of petroleum waxes, vegetable waxes, animal-fat waxes, synthetic waxes and mixtures thereof.

3. The candle composition of claim 1, wherein the plurality of wax fuels comprises two wax fuels having a weight percent ratio of one to the other ranging from about 20:80 to about 80:20.

4. The candle composition of claim 1, wherein the wax base is present in an amount of at least 50 weight percent.

5. The candle composition of claim 1, therein the copolymer additive is present in an amount ranging from about 0.125 to about 10 weight percent.

6. The candle composition of claim 5 wherein the copolymer additive is present in an amount ranging from about 0.25 to about 2 about weight percent.

7. The candle composition of claim 1 further comprising a free oil.

8. The candle composition of claim 1 further comprising at least one free oil selected from the group consisting of hydrocarbon oil, vegetable oil and mixtures thereof.

9. The candle composition of claim 1, further comprising:
from about 0 to about 10 weight percent fragrance;
from about 0 to 1 weight percent stabilizers;
from about 0 to about 2 weight percent dyes; and
from about 0 to about 10 weight percent hydrocarbon oil from about 0 to about 10 weight percent of a vegetable oil.

10. A candle comprising:
at lease one wick;
a body, said at least one wick being disposed within said body; and
wherein said body comprises a wax base comprising a plurality of different wax fuels and a copolymer additive selected from the group consisting of diblock, triblock, radial block, multiblock copolymers of synthetic thermoplastic rubbers and mixtures thereof.

11. The candle of claim 10, wherein said plurality of different wax fuels comprises a mixture of petroleum wax and vegetable wax in a ratio ranging from about 80:20 to about 20:80.

12. The candle of claim 10, wherein said plurality of different wax fuels comprises a mixture of vegetable matter and synthetic matter ranging from about 80:20 to about 20:80.

13. The candle of claim 10, wherein said plurality of wax fuels comprises a mixture of animal-fat matter and petroleum matter in a ratio ranging from about 80:20 to about 20:80.

14. The candle of claim 10, wherein said plurality of different wax fuels comprises a mixture of synthetic matter and petroleum matter in a ratio ranging from about 80:20 to about 20:80.

15. The candle of claim 10, where said plurality of different wax fuels comprise a combination of 3 or more materials selected from the group consisting of petroleum waxes, vegetable waxes, animal-fat waxes and synthetic waxes.

16. The candle of claim 10, wherein said wax base is present in an amount of at least 50 weight percent.

17. The candle of claim 11, wherein said copolymer additive is present in an amount ranging from about 0.125 to about 10 weight percent.

18. The candle of claim 11, wherein said copolymer additive is present in an amount ranging from about 0.25 to about 2 weight percent.

19. The candle of claim 10, wherein the body further comprises:
from about 0 to about 10 weight percent fragrance;
from about 0 to about 1 weight percent stabilizers;
from about 0 to about 2 weight percent dyes;
from about 0 to about 10 weight percent hydrocarbon oil; and
from about 0 to about 10 weight percent of a vegetable oil.

20. A method making candles comprising:
providing a molten candle composition comprising a wax base comprising a plurality of different wax fuels and a copolymer additive selected from the group consisting of diblock, triblock, radial block, multiblock copolymers of synthetic thermoplastic rubbers, and mixtures thereof;
placing the molten candle composition in a mold to form a candle body;
placing a wick in the molten candle composition; and
allowing the candle composition to harden.

21. The method of claim 20, wherein the plurality of different wax fuels comprises a mixture of petroleum matter and vegetable in a ratio ranging from about 80:20 to about 20:80.

22. The method of claim 20, wherein the plurality of different wax fuels comprises a mixture of vegetable matter and synthetic matter in a ratio ranging from about 80:20 to about 20:80.

23. The method of claim 20, wherein the plurality of different wax fuels comprises a mixture of animal-fat matter and petroleum matter in a ratio ranging from about 80:20 to about 20:80.

24. The method of claim 20, wherein the plurality of different wax fuels comprises a mixture of synthetic matter and petroleum matter in a ratio ranging from about 80:20 to about 20:80.

25. The method of claim 20, wherein the plurality of different wax fuels comprises a combination of 3 or more materials selected from the group consisting of petroleum waxes, vegetable waxes, animal-fat waxes and synthetic waxes.

26. The method of claim 20, wherein the wax base is present in an amount of at least 50 weight percent.

27. The method of claim 20, wherein the copolymer additive is present in an amount ranging from about 0.125 to about 10 weight percent.

28. The method of claim 20, wherein the copolymer additive is present in an amount ranging from about 0.25 to about 2 weight percent.

29. The method of claim 20, wherein the candle composition further comprises:
from about 0 to about 10 weight percent fragrance;
from about 0 to about 1 weight percent stabilizers;
from about 0 to about 2 weight percent dyes; and
from about 0 to about 10 weight percent hydrocarbon oils; and
from about 0 to about 10 weight percent vegetable oils.

30. The method of claim 20, wherein the method further comprises the step of creating a pre-mix of the wax base and a synthetic thermoplastic rubber.

31. The method of claim 20, wherein the wick is predisposed in the mold/container before the molten candle composition is inserted into the mold/container.
